(19) United States
(12) Patent Application Publication
(10) Pub. No.: US 2010/0060654 A1
(43) Pub. Date: Mar. 11, 2010

(54) VIDEO PROCESSOR AND MEMORY MANAGEMENT METHOD THEREOF

(75) Inventor: Zong-Zian Lin, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ALi Corporation, Taipei (TW)

(21) Appl. No.: 12/400,030

(22) Filed: Mar. 9, 2009

(30) Foreign Application Priority Data
Sep. 5, 2008 (CN) 200810215318.6

(51) Int. Cl. G06F 13/00

(52) U.S. Cl. 345/536

(57) ABSTRACT

Video processors and memory management methods thereof are provided, wherein the video processor is controlled by a central processing unit, and is coupled to a system memory to receive a macroblock. The video processor has two local memories, a control circuit and an image processing unit. The control circuit divides the macroblock into pixel segments, and disposes the pixel segments in the two local memories. The image processing unit accesses the two local memories for executing an image processing procedure. The system memory is refreshed by a processed macroblock in the two local memories.

### CROSS REFERENCE TO RELATED APPLICATIONS

This Application claims priority of China Patent Application No. 200810215318.6, filed on Sep. 5, 2008, the entirety of which is incorporated by reference herein.

### BACKGROUND OF THE INVENTION

1. Field of the Invention

The present invention relates to video processing techniques, and in particular relates to memory management for a macroblock.

2. Description of the Related Art

FIG. 1 is a sketch of one macroblock. A macroblock usually includes 16×16 pixel data, which can be divided into sixteen 4×4 pixel arrays. Referring to FIG. 1, which shows 16 blocks, each block is a 4×4 pixel array. For example, block B represents a 4×4 pixel array.

The macroblock is usually introduced into deblocking technique of video compression. One well-known video compression technique is the H.264.

There are two mechanisms for deblocking, one is a horizontal deblocking mechanism and the other one is a vertical deblocking mechanism. The horizontal deblocking mechanism deblocks eight consecutive pixel data of the same row at a time. The vertical deblocking mechanism deblocks eight consecutive pixel data of the same column at a time. Referring to FIG. 1, the eight arrows V₁, V₂, V₃, V₄, H₁, H₂, H₃, and H₄ are for deblocking one macroblock. Each of the arrows V₁, V₂, V₃ and V₄ relates to 16 horizontal deblockings (for 16 rows), and each of the arrows H₁, H₂, H₃ and H₄ relates to 16 vertical deblockings (for 16 columns).

The following recites some examples to help understand the meaning of the arrows V₁, V₂, V₃, V₄, H₁, H₂, H₃, and H₄. FIG. 2 shows a pixel array comprising a macroblock 100. For the first row of the macroblock 100, the horizontal deblocking mechanism indicated by the arrow V₁ deblocks the eight pixel data in a horizontal deblocking block 102. The horizontal deblocking block 102 includes four pixel data at the left side of the arrow V₁ and four pixel data at the right side of the arrow V₁. For each row, the horizontal deblocking block indicted by the arrow V₁ includes four pixel data at the left side of the arrow V₁ and four pixel data at the right side of the arrow V₁. The horizontal deblocking blocks indicated by other arrows V₂, V₃ and V₄ are similarly designed. For the first column of the macroblock 100, the vertical deblocking indicated by the arrow H₁ deblocks the eight pixel data in a vertical deblocking block 104. The vertical deblocking block 102 includes four pixel data at the upper side of the arrow H₁ and four pixel data at the lower side of the arrow H₁. For each row, the vertical deblocking block indicted by the arrow H₁ includes four pixel data at the upper side of the arrow H₁ and four pixel data at the lower side of the arrow H₁. The vertical deblocking blocks indicated by other arrows H₂, H₃ and H₄ are similarly designed.

Because the pixel data is modified during the horizontal or vertical deblockings, the horizontal or vertical deblockings have to be executed in a specific order. An exemplary embodiment of macroblock deblocking procedure starts from horizontal deblockings indicated by the arrow V₁, V₂, V₃ and V₄ and then the vertical deblockings indicated by the arrows H₁, H₂, H₃, and H₄ are executed. The horizontal deblockings indicated by the arrow V₁ are executed prior to the horizontal deblockings indicated by the arrow V₂. The horizontal deblockings indicated by the arrow V₂ are executed prior to the horizontal deblockings indicated by the arrow V₃. The horizontal deblockings indicated by the arrow V₃ are executed prior to the horizontal deblockings indicated by the arrow V₄. The horizontal deblockings indicated by the arrow V₄ are executed prior to the vertical deblockings indicated by the arrow H₁. The vertical deblockings indicated by the arrow H₁ are executed prior to the vertical deblockings indicated by the arrow H₂. The vertical deblockings indicated by the arrow H₂ are executed prior to the vertical deblockings indicated by the arrow H₃. The vertical deblockings indicated by the arrow H₃ are executed prior to the vertical deblockings indicated by the arrow H₄.

Conventional techniques usually provide a system memory, such as DRAM, and a plurality of registers for macroblock deblocking. Before the macroblock deblocking procedure, the macroblock is installed in the system DRAM. During the macroblock deblocking procedure, the registers temporarily store the pixel data retrieved from the system DRAM and, instead of accessing the system DRAM, the deblocking processor accesses the registers to avoid excessive and frequent access of the system DRAM. The system DRAM is refreshed by the deblocked pixel data in the registers. Since the macroblock deblocking procedure is very complex, the number of registers required is numerous. Thus, the conventional techniques for deblocking filtering are very expensive.

### BRIEF SUMMARY OF THE INVENTION

The invention discloses video processors and memory management methods thereof. The video processor is controlled by a central processing unit and coupled to a system memory to receive a macroblock. The video processor comprises two local memories, a control circuit and an image processing unit. The two local memories are controlled by the control circuit. The control circuit divides the macroblock into pixel segments, and disposes the pixel segments in the two local memories. The local memories are read and refreshed by the image processing unit executing an image processing procedure. The system memory is refreshed by the processed macroblock in the local memories.

Each pixel segment comprises several consecutive pixel data in a row. The pixel data of a pixel segment is stored in the same local memory with the same address. In a row, the adjacent pixel segments are stored in different local memories.

An exemplary embodiment of the video processor of the invention realizes the local memories by using static random access memories labeled SRAM₁ and SRAM₂, respectively. The pixel data of the macroblock are labeled by P (i, j), where i and j are variables indicating that the pixel datum is in the i^{th} row and the j^{th} column of the macroblock. The control unit may store the pixel segments in the two local memories SRAM₁ and SRAM₂ according to a memory management procedure. The memory management procedure comprises: storing the pixel data P(1, 1)˜P(1, 4) and P(3, 1)˜P(3, 4) in a first address of the local memory SRAM₁, storing the pixel data P(2, 1)˜P(2, 4) and P(4, 1)˜P(4, 4) in a first address of the local memory SRAM₂, storing the pixel data P(5, 1) P(5, 4) and P(7, 1)˜P(7, 4) in a second address of the local memory SRAM₁, storing the pixel data P(6, 1)˜P(6, 4) and P(8, 1)˜P(8, 4) in a second address of the local memory SRAM₂, storing the pixel data P(1, 5)˜P(1, 8) and P(3, 5)˜P(3, 8) in a third address of the local memory SRAM₂, storing the pixel data P(2, 5)˜P(2, 8) and P(4, 5)˜P(4, 8) in a third address of the local memory SRAM₁, storing the pixel data P(5, 5)˜P(5, 8) and P(7, 5)˜P(7, 8) in a fourth address of the local memory SRAM₂, and storing the pixel data P(6, 5)˜P(6, 8) and P(8, 5)˜P(8, 8) in a fourth address of the local memory SRAM₁.

This paragraph recites another exemplary embodiment of the video processor of the invention, wherein, compared to the aforementioned embodiment, the pixel data P(5, 1)˜P(5, 8), P(6, 1)˜P(6, 8), P(7, 1)˜P(7, 8) and P(8, 1)˜P(8, 8) is stored in the local memories SRAM₁ and SRAM₂ in a different way. The pixel data P(5, 1)˜P(5, 4) and P(7, 1)˜P(7,4) is stored in a second address of the local memory SRAM₂, the pixel data P(6, 1) P(6, 4) and P(8, 1)˜P(8,4) is stored in a second address of the local memory SRAM₁. The pixel data P(5, 5)˜P(5, 8) and P(7, 5)˜P(7, 8) is stored in a fourth address of the local memory SRAM₁. The pixel data P(6, 5)˜P(6, 8) and P(8, 5)˜P(8, 8) is stored in a fourth address of the local memory SRAM₂.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a sketch of one macroblock;

FIG. 2 shows a pixel array comprising a macroblock;

FIG. 3 is a block diagram sketching an embodiment of the video processor of the invention;

FIG. 4A and FIG. 4B illustrate an embodiment of the memory management procedure of the first and second local memories SRAM₁ and SRAM₂;

FIG. 5A and FIG. 5B illustrate another embodiment of the memory management procedure of the first and second local memories SRAM₁ and SRAM₂; and

FIG. 6 is a flowchart of the video processing procedure of the invention.

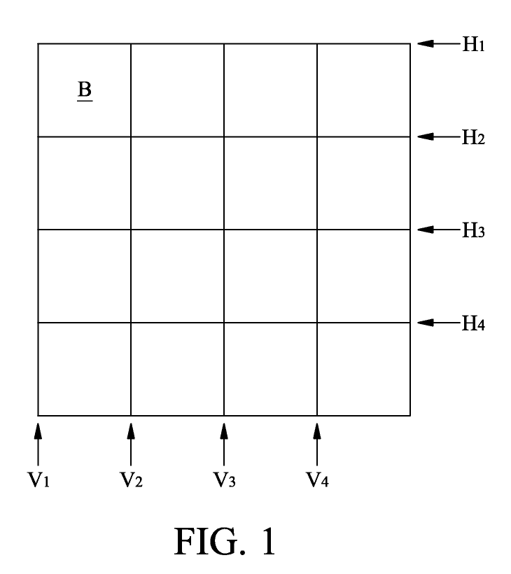

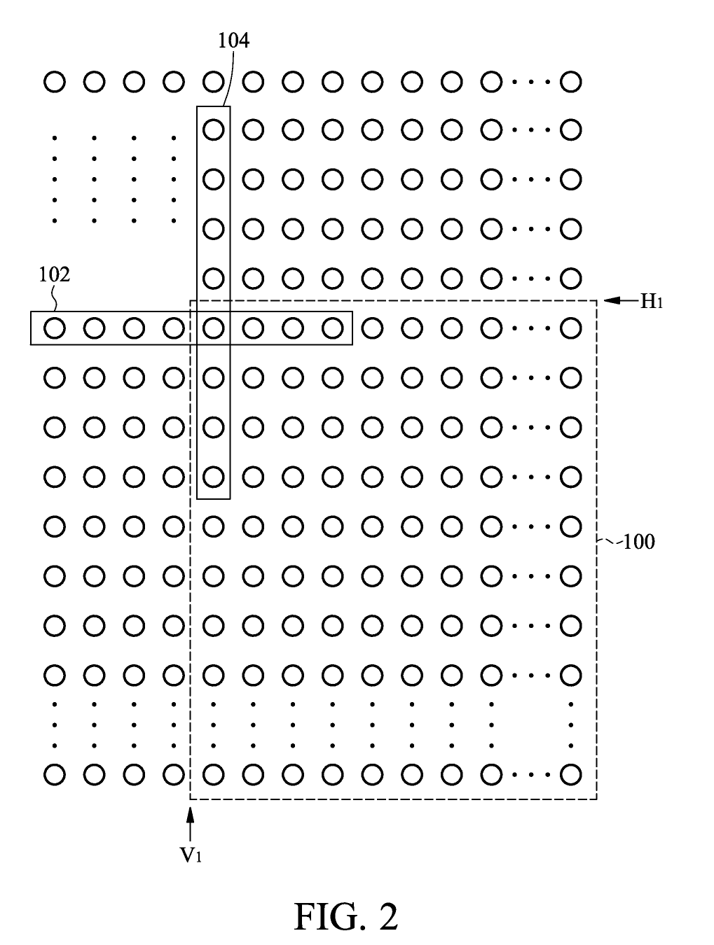

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

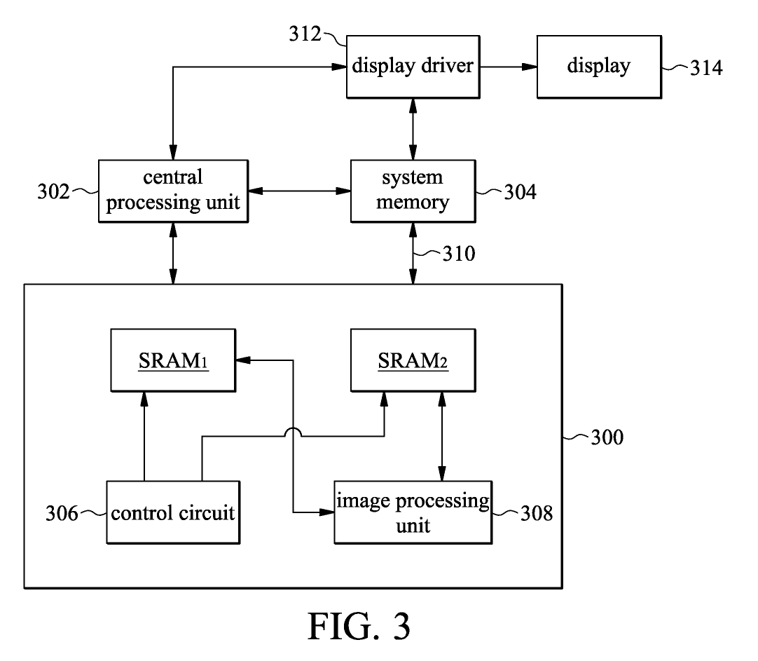

FIG. 3 is a block diagram, comprising an embodiment of the video processor of the invention. The video processor 300 is controlled by a central processing unit 302, and is coupled to a system memory 304 to retrieve a macroblock. The system memory 304 may be a dynamic random access memory (DRAM).

The video processor 300 comprises two local memories (may be static random access memories, SRAMs, labeled SRAM₁ and SRAM₂, respectively), a control circuit 306 and an image processing unit 308. The control circuit 306 divides the macroblock retrieved from the system memory 304 into pixel segments, and disposes the pixel segments in the first and second local memories SRAM₁ and SRAM₂ according to a memory management procedure. The first and second local memories SRAM₁ and SRAM₂ are read and refreshed by the image processing unit 308 executing an image processing procedure. The system memory 304 is refreshed by the processed macroblock in the first and second local memories SRAM₁ and SRAM₂. Symbol 310 represents the macroblock transmission between the system memory 304 and the video processor 300. The central processing unit 302 further controls the display driver 312 to access the system memory 304 for the processed macroblock and to drive the display 314 to show the processed macroblock.

An SRAM is easier to read and write than a DRAM. When executing an image processing procedure, the image processing unit 308 reads and writes to the first and second local memories SRAM₁ and SRAM₂ rather than accessing the system DRAM 304. This avoids excessive and frequent access of the system DRAM 304, and substantially improves the efficiency of the video processor 300.

The invention provides several techniques to store the macroblock in the first and second local memories SRAM₁ and SRAM₂. Each pixel segment comprises several consecutive pixel data in a row. The pixel data of a pixel segment is stored in the same local memory with the same address. In a row, the adjacent pixel segments are stored in different local memories.

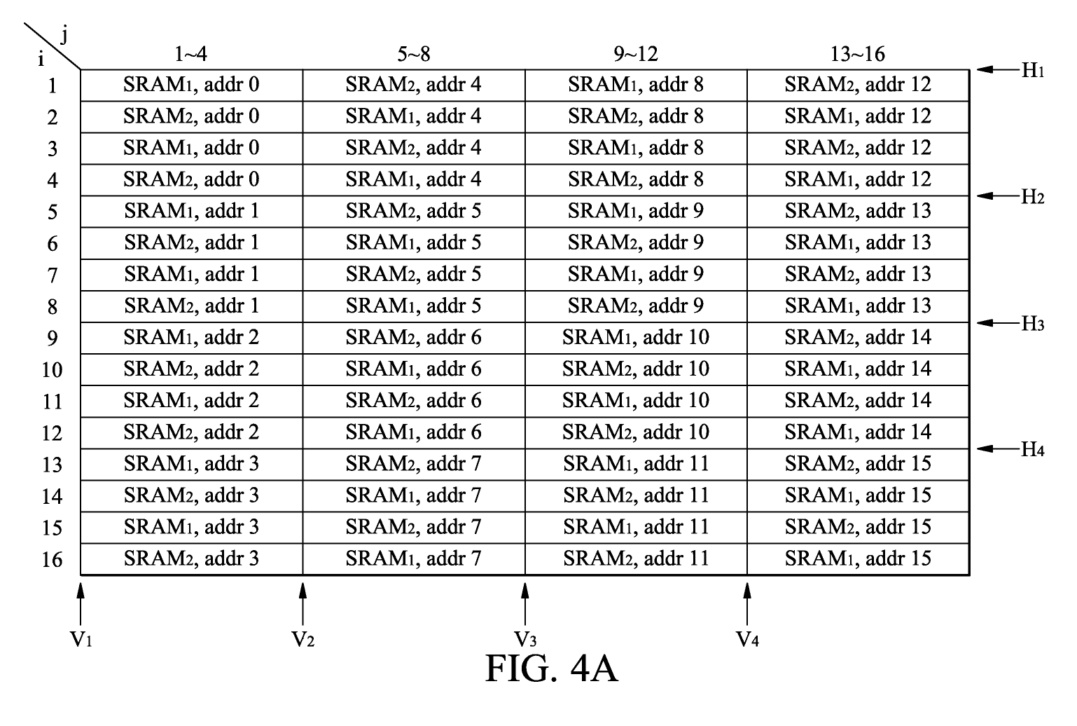

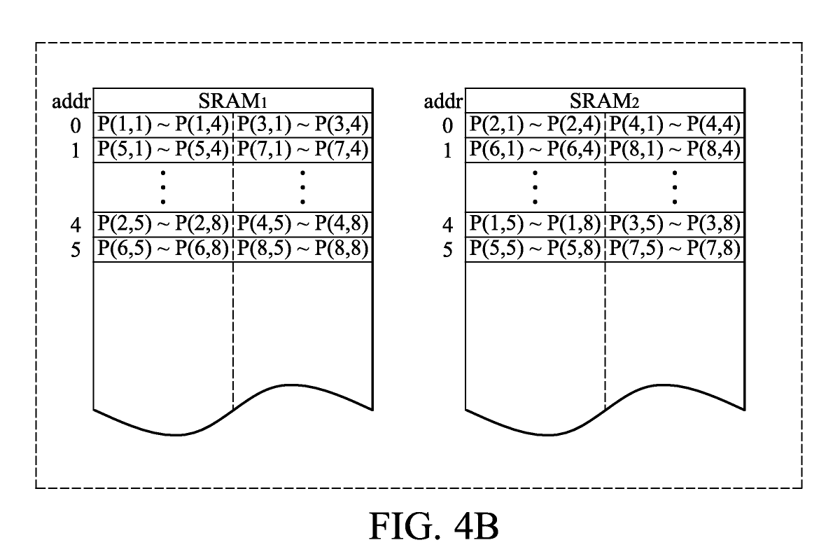

FIGS. 4A and 4B illustrate an embodiment of the memory management procedure of the first and second local memories SRAM₁ and SRAM₂. The pixel data of the macroblock are labeled by P(i, j), where i and j are variables indicating that the pixel datum is in the i^{th} row and the j^{th} column of the macroblock. FIG. 4A illustrates a macroblock. The cells of FIG. 4A represent pixel segments and labels thereon show the corresponding local memories and addresses. Each pixel segment comprises four consecutive pixel data that are of the same row. FIG. 4B shows how the first and second local memories SRAM₁ and SRAM₂ store the macroblock.

The macroblock (16×16 pixel array) comprises four 8×8 pixel arrays. The following takes the 8×8 pixel array wherein i=1˜8 and j=1˜8 as an example to recite a memory management procedure of the first and second local memories SRAM₁ and SRAM₂.

In the embodiment shown in FIGS. 4A and 4B, the pixel data P(1, 1), P(1, 2), P(1, 3), P(1, 4), P(3, 1), P(3, 2), P(3, 3) and P(3, 4) is stored in a first address of the first local memory SRAM₁, such as address 0 of the first local memory SRAM₁ (labeled SRAM₁, addr0); the pixel data P(2, 1), P(2, 2), P(2, 3), P(2, 4), P(4, 1), P(4, 2), P(4, 3) and P(4, 4) is stored in a first address of the second local memory SRAM₂, such as address 0 of the second local memory SRAM₂ (labeled SRAM₂, addr0); the pixel data P(5, 1), P(5, 2), P(5, 3), P(5, 4), P(7, 1), P(7, 2), P(7, 3) and P(7, 4) is stored in a second address of the first local memory SRAM₁, such as address 1 of the first local memory SRAM₁ (labeled SRAM₁, addr1); the pixel data P(6, 1), P(6, 2), P(6, 3), P(6, 4), P(8, 1), P(8, 2), P(8, 3) and P(8, 4) is stored in a second address of the second local memory SRAM₂, such as address 1 of the second local memory SRAM₂ (labeled SRAM₂, addr1); the pixel data P(1, 5), P(1, 6), P(1, 7), P(1, 8), P(3, 5), P(3, 6), P(3, 7) and P(3, 8) is stored in a third address of the second local memory SRAM₂, such as address 4 of the second local memory SRAM₂ (labeled SRAM₂, addr4); the pixel data P(2, 5), P(2, 6), P(2, 7), P(2, 8), P(4, 5), P(4, 6), P(4, 7) and P(4, 8) is stored in a third address of the first local memory SRAM₁, such as address 4 of the first local memory SRAM₁ (labeled SRAM₁, addr4); the pixel data P(5, 5), P(5, 6), P(5, 7), P(5, 8), P(7, 5), P(7, 6), P(7, 7) and P(7, 8) is stored in a fourth address of the second local memory SRAM₂, such as address 5 of the second local memory SRAM₂ (labeled SRAM₂, addr5); and the pixel data P(6, 5), P(6, 6), P(6, 7), P(6, 8), P(8, 5), P(8, 6), P(8, 7) and P(8, 8) is stored in a fourth address of the first local memory SRAM₁, such as address 5 of the first local memory SRAM₁ (labeled SRAM₁, addr5).

Referring to FIG. 4A, the other three 8×8 pixel arrays all follow the local memory allocation rule of the 8×8 pixel array (with i=1˜8 and j=1˜8). The 8×8 pixel array wherein i=9˜16 and j=1˜8 is stored in addresses 2, 3, 6 and 7 (labeled addr2, addr3, addr6 and addr7, respectively) of the first and second local memories SRAM₁ and SRAM₂. The 8×8 pixel array wherein i=1˜8 and j=9˜16 is stored in addresses 8, 9, 12 and 13 (labeled addr8, addr9, addrl2 and addrl3, respectively) of the first and second local memories SRAM₁ and SRAM₂. The 8×8 pixel array wherein i=9˜16 and j=9˜16 is stored in addresses 10, 11, 14 and 15 (labeled addr10, addr11, addrl4 and addrl5, respectively) of the first and second local memories SRAM₁ and SRAM₂.

The following recites local memory access techniques for deblocking. For example, to execute a first row (i=1) horizontal deblocking mechanism as indicated by the arrow V₂, the image processing unit (308 of FIG. 3) gets pixel data P(1, 1)˜P(1, 8) by reading address 0 of the first local memories SRAM₁ and address 4 of the second local memory SRAM₂. After the horizontal deblocking, the image processing unit 308 restores the modified pixel data P(1, 1)˜P(1, 4) to address 0 of the first local memories SRAM₁ and restores the modified pixel data P(1, 5)˜P(1, 8) to address 4 of the second local memories SRAM₂. Thus, following horizontal or vertical deblockings can utilize the modified pixel data (1, 1)˜P(1, 8) by accessing address 0 of the first local memories SRAM₁ and address 4 of the second local memory SRAM₂.

Some exceptions of horizontal deblocking may require the pixel data in the previous macroblock. For example, a first row (i=1) horizontal deblocking procedure indicated by the arrow V₁ requires not only pixel data in the present macroblock (P(1, 1)˜P(1, 4) of the previous macroblock) but also pixel data in the previous macroblock (P(1, 13)˜P(1, 16) of the left macroblock). In a case wherein pixel data P(1, 13)˜P(1, 16) of the left macroblock is stored in address 28 of the second local memory SRAM₂, the image processing unit 308 can collect the required data for the first row horizontal deblocking procedure (indicated by the arrow V₁) by reading address 0 of the first local memory SRAM₁ and address 28 of the second local memory SRAM₂. After the horizontal deblocking procedure, the modified pixel data is sent back to the local memories SRAM₁ and SRAM₂ to refresh their previous value and to be accessed by the following horizontal or vertical deblockings.

When the horizontal deblockings of the macroblock are all finished, the vertical deblockings of the macroblock may be realized in a specific designed order rather than that mentioned in the background. The vertical deblockings may be in the following order: first column (j=1) vertical deblocking procedure indicated by an arrow H₁, first column vertical deblocking procedure indicated by an arrow H₂, . . . , first column vertical deblocking procedure indicated by an arrow H₄, second column (=2) vertical deblocking procedure indicated by an arrow H₁, second column vertical deblocking procedure indicated by an arrow H₂, . . . , and 16^{th} column (=16) vertical deblocking procedure indicated by an arrow H₄.

This paragraph recites the first column (j=1) vertical deblocking mechanism indicated by arrow H₁. The required pixel data include pixel data P(1, 1)˜P(4, 1) of the present macroblock and pixel data P(13, 1)˜P(16, 1) of the upper macroblock. Pixel data P(1, 1)˜P(4, 1) of the present macroblock is available by reading the address 0 of the first and second local memories SRAM₁ and SRAM₂. Pixel data P(13, 1)˜P(16, 1) of the upper macroblock is also available since the data has been deblocked before and has been already stored in storage elements, such as a register. The local memory design of the invention makes it very easy to process vertical deblockings.

Compared with conventional techniques wherein the pixel data is stored in registers, the invention using two SRAMs to store pixel data, increasing deblocking speed and decreasing required size.

Instead of the deblocking procedure, the image processing procedure may be image rotation. The system DRAM (304 of FIG. 3) provides pixel data to be stored in the first and second local memories SRAM₁ and SRAM₂ according to the memory management procedure shown in FIGS. 4A and 4B. A rotated image is available by reading out the pixel data from the local memories SRAM₁ and SRAM₂ in a specially designed readout order and then writing them back to the local memories SRAM₁ and SRAM₂ in a specially designed writeback order.

The image processing procedure executed by the image processing unit is not limited to deblocking or image rotation procedures. Any image processing techniques involving the memory management procedure shown in our specification is within the scope of the invention. Furthermore, the dimension of the pixel array is not to limit the scope of the invention. Any pixel array comprising a 8×8 pixel array stored into two local memories according to the memory management procedure of the invention is within the scope of the invention.

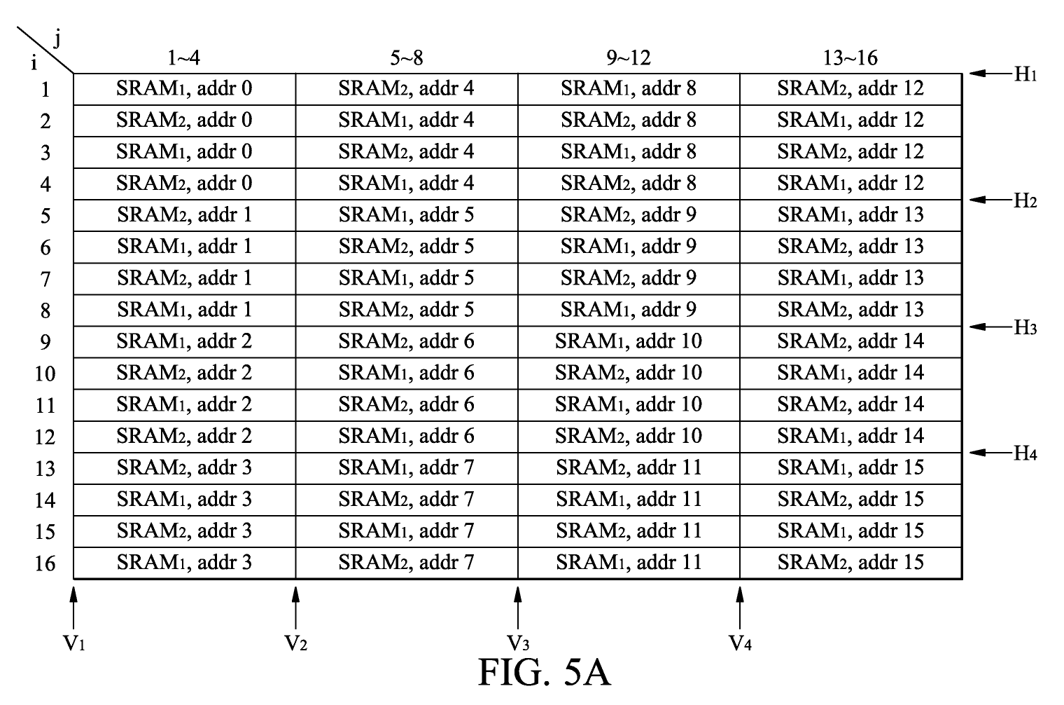

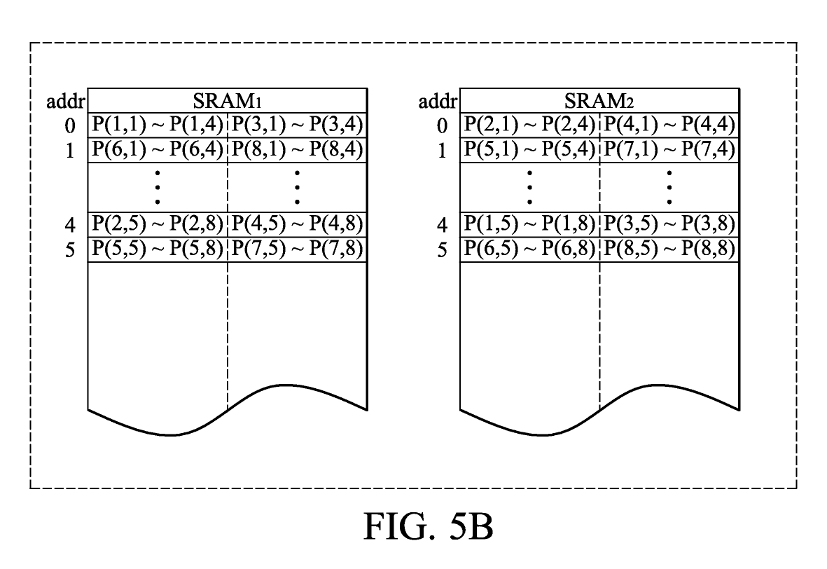

The video compression technique H.264 further comprises an MBAFF encoding technique, wherein the present macroblock is of a frame type and its upper macroblock is of a field type. FIGS. 5A and 5B illustrate the memory management procedure for the MBAFF encoding technique. The following takes the 8×8 pixel array wherein i=1˜8 and j=1˜8 as an example to characterize the memory management procedure. Compared with the memory management procedure of FIGS. 4A and 4B, the technique of FIGS. 5A and 5B stores the pixel data P(i=5˜8, j=1˜8) in another way. The pixel data P(5, 1)˜P(5, 4) and P(7, 1)˜P(7,4) is stored in address 1 of the second local memory SRAM₂ (labeled SRAM₂, addr1). The pixel data P(6, 1)˜P(6, 4) and P(8, 1)˜P(8,4) is stored in address 1 of the first local memory SRAM₁ (labeled SRAM₁, addr1). The pixel data P(5, 5)˜P(5, 8) and P(7, 5)˜P(7, 8) is stored in address 5 of the first local memory SRAM₁ (labeled SRAM₁, addr5). The pixel data P(6, 5)˜P(6, 8) and P(8, 5)˜P(8, 8) is stored in address 5 of the second local memory SRAM₂ (labeled SRAM₂, addr5). In the macroblock shown in FIG. 5A, the other three 8×8 pixel arrays follow the local memory allocation rule of the 8×8 pixel array (with i=1˜8 and j=1˜8).

This paragraph recites a first column (j=1) vertical deblocking procedure indicated by an arrow H₁ wherein the video compression uses an MBAFF encoding technique. As shown in FIG. 5A, the required pixel data are pixel data P(1, 1), P(3, 1), P(5, 1) and P(7, 1) of the present macroblock and four pixel data of the upper macroblock. Pixel data P(1, 1), P(3, 1), P(5, 1) and P(7, 1) of the present macroblock are available by reading address 0 of the first local memory SRAM₁ and address 1 of the second local memory SRAM₂. The pixel data in the upper macroblock are also available since the data has been deblocked before and has been already stored in storage elements, such as a register. The memory management procedure of the invention makes it very easy to process vertical deblockings for video encoded in an MBAFF.

The local memory configuration of FIGS. 5A and 5B is not limited to video of MBAFF encoding, it can be further applied to videos of other encoding techniques. Furthermore, the dimension of the pixel array is not to limit the scope of the invention. Any pixel array comprising a 8×8 pixel array stored into two local memories according to the memory management procedure of the invention is within the scope of the invention.

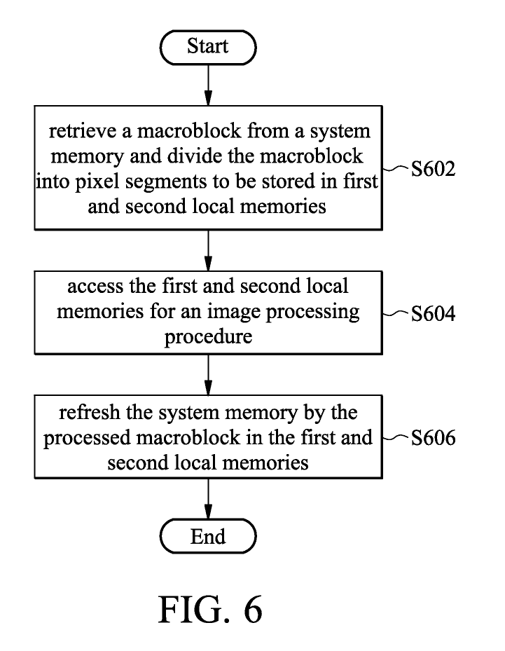

FIG. 6 is a flowchart of the video processing procedure of the invention. In step S602, a macroblock is read from a system memory (304 of FIG. 3) and is divided into pixel segments to be disposed in first and second local memories (SRAM₁ and SRAM₂ of FIG. 3). In step S604, the first and second local memories SRAM₁ and SRAM₂ are accessed for an image processing procedure. In step S606, the processed macroblock in the first and second local memories SRAM₁ and SRAM₂ are sent back to the system memory 304 to refresh the previous macroblock.

The image processing procedure may be a deblocking or image rotation procedure and so on. Techniques involving the memory management procedure shown in the invention are within the scope of the invention.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video processor, controlled by a central processing unit and coupled to a system memory to receive a macroblock, comprising:
a first local memory;
a second local memory;
a control circuit, dividing the macroblock into pixel segments and disposing the pixel segments for storing in the first and second local memories; and
an image processing unit, accessing the first and second local memories for executing an image processing procedure,
wherein the system memory is refreshed by an processed macroblock stored in the first and second local memories.

2. The video processor as claimed in claim 1, wherein each pixel segment comprises a plurality of adjacent pixels in a row, and the pixels of a pixel segment is stored in the same local memory with the same address, and the adjacent pixel segments in a row is stored in different local memories.

3. The video processor as claimed in claim 1, wherein each the pixel segment comprises four adjacent pixels and the control unit disposes the pixel segments for storing in the first and second local memories comprising:
storing P(1, 1), P(1, 2), P(1, 3), P(1, 4), P(3, 1), P(3, 2), P(3, 3) and P(3, 4) in a first address of the first local memory;
storing P(2, 1), P(2, 2), P(2, 3), P(2, 4), P(4, 1), P(4, 2), P(4, 3) and P(4, 4) in a first address of the second local memory;
storing P(5, 1), P(5, 2), P(5, 3), P(5, 4), P(7, 1), P(7, 2), P(7, 3) and P(7, 4) in a second address of the first local memory;
storing P(6, 1), P(6, 2), P(6, 3), P(6, 4), P(8, 1), P(8, 2), P(8, 3) and P(8, 4) in a second address of the second local memory;
storing P(1, 5), P(1, 6), P(1, 7), P(1, 8), P(3, 5), P(3, 6), P(3, 7) and P(3, 8) in a third address of the second local memory;
storing P(2, 5), P(2, 6), P(2, 7), P(2, 8), P(4, 5), P(4, 6), P(4, 7) and P(4, 8) in a third address of the first local memory;
storing P(5, 5), P(5, 6), P(5, 7), P(5, 8), P(7, 5), P(7, 6), P(7, 7) and P(7, 8) in a fourth address of the second local memory; and
storing P(6, 5), P(6, 6), P(6, 7), P(6, 8), P(8, 5), P(8, 6), P(8, 7) and P(8, 8) in a fourth address of the first local memory,
wherein P(i, j) represents the location of pixel data in the i^{th} row and the j^{th} column of the macroblock and the i and j are variables.

4. The video processor as claimed in claim 1, wherein each the pixel segment comprises four adjacent pixels and the control unit disposes the pixel segments for storing in the first and second local memories comprising:
storing P(1, 1), P(1, 2), P(1, 3), P(1, 4), P(3, 1), P(3, 2), P(3, 3) and P(3, 4) in a first address of the first local memory;
storing P(2, 1), P(2, 2), P(2, 3), P(2, 4), P(4, 1), P(4, 2), P(4, 3) and P(4, 4) in a first address of the second local memory;
storing P(5, 1), P(5, 2), P(5, 3), P(5, 4), P(7, 1), P(7, 2), P(7, 3) and P(7, 4) in a second address of the second local memory;
storing P(6, 1), P(6, 2), P(6, 3), P(6, 4), P(8, 1), P(8, 2), P(8, 3) and P(8, 4) in a second address of the first local memory;
storing P(1, 5), P(1, 6), P(1, 7), P(1, 8), P(3, 5), P(3, 6), P(3, 7) and P(3, 8) in a third address of the second local memory;
storing P(2, 5), P(2, 6), P(2, 7), P(2, 8), P(4, 5), P(4, 6), P(4, 7) and P(4, 8) in a third address of the first local memory;
storing P(5, 5), P(5, 6), P(5, 7), P(5, 8), P(7, 5), P(7, 6), P(7, 7) and P(7, 8) in a fourth address of the first local memory; and
storing P(6, 5), P(6, 6), P(6, 7), P(6, 8), P(8, 5), P(8, 6), P(8, 7) and P(8, 8) in a fourth address of the second local memory,
wherein P(i, j) represents the location of pixel data in the i^{th} row and the j^{th} column of the macroblock and the i and j are variables.

5. The video processor as claimed in claim 1, wherein the first and second local memories are static random access memories.

6. A video processing method, comprising:
retrieving a macroblock from a system memory;
dividing the macroblock into pixel segments to dispose for a first and a second local memory;
accessing the first and second local memories for executing an image processing procedure; and
refreshing the system memory by a processed macroblock in the first and second local memories.

7. The method as claimed in claim 6, wherein each pixel segment comprises a plurality of adjacent pixels in a row, and the pixels of a pixel segment is stored in the same local memory with the same address, and the pixel segments adjacent to each other in a row is stored in different local memories.

8. The method as claimed in claim 6, wherein each pixel segment comprises four adjacent pixels, and the step of disposing the pixel segments in the first and second local memories comprises:
storing one pixel segment of P(1, 1), P(1, 2), P(1, 3) and P(1, 4) and another pixel segment of P(3, 1), P(3, 2), P(3, 3) and P(3, 4) in a first address of the first local memory;
storing one pixel segment of P(2, 1), P(2, 2), P(2, 3) and P(2, 4) and another pixel segment of P(4, 1), P(4, 2), P(4, 3) and P(4, 4) in a first address of the second local memory;
storing one pixel segment of P(5, 1), P(5, 2), P(5, 3) and P(5, 4) and another pixel segment of P(7, 1), P(7, 2), P(7, 3) and P(7, 4) in a second address of the first local memory;
storing one pixel segment of P(6, 1), P(6, 2), P(6, 3) and P(6, 4) and another pixel segment of P(8, 1), P(8, 2), P(8, 3) and P(8, 4) in a second address of the second local memory;
storing one pixel segment of P(1, 5), P(1, 6), P(1, 7) and P(1, 8) and another pixel segment of P(3, 5), P(3, 6), P(3, 7) and P(3, 8) in a third address of the second local memory;
storing one pixel segment of P(2, 5), P(2, 6), P(2, 7) and P(2, 8) and another pixel segment of P(4, 5), P(4, 6), P(4, 7) and P(4, 8) in a third address of the first local memory;
storing one pixel segment of P(5, 5), P(5, 6), P(5, 7) and P(5, 8) and another pixel segment of P(7, 5), P(7, 6), P(7, 7) and P(7, 8) in a fourth address of the second local memory; and
storing one pixel segment of P(6, 5), P(6, 6), P(6, 7) and P(6, 8) and another pixel segment of P(8, 5), P(8, 6), P(8, 7) and P(8, 8) in a fourth address of the first local memory,
wherein i and j are variables and P(i, j) represents pixel datum in the i^{th} row and the j^{th} column of the macroblock.

9. The method as claimed in claim 6, wherein each pixel segment comprises four pixel data, and the step of storing the pixel segments in the first and second local memories comprises:
storing one pixel segment of P(1, 1), P(1, 2), P(1, 3) and P(1, 4) and another pixel segment of P(3, 1), P(3, 2), P(3, 3) and P(3, 4) in a first address of the first local memory;
storing one pixel segment of P(2, 1), P(2, 2), P(2, 3) and P(2, 4) and another pixel segment of P(4, 1), P(4, 2), P(4, 3) and P(4, 4) in a first address of the second local memory;
storing one pixel segment of P(5, 1), P(5, 2), P(5, 3) and P(5, 4) and another pixel segment of P(7, 1), P(7, 2), P(7, 3) and P(7, 4) in a second address of the second local memory;
storing one pixel segment of P(6, 1), P(6, 2), P(6, 3) and P(6, 4) and another pixel segment of P(8, 1), P(8, 2), P(8, 3) and P(8, 4) in a second address of the first local memory;
storing one pixel segment of P(1, 5), P(1, 6), P(1, 7) and P(1, 8) and another pixel segment of P(3, 5), P(3, 6), P(3, 7) and P(3, 8) in a third address of the second local memory;
storing one pixel segment of P(2, 5), P(2, 6), P(2, 7) and P(2, 8) and another pixel segment of P(4, 5), P(4, 6), P(4, 7) and P(4, 8) in a third address of the first local memory;
storing one pixel segment of P(5, 5), P(5, 6), P(5, 7) and P(5, 8) and another pixel segment of P(7, 5), P(7, 6), P(7, 7) and P(7, 8) in a fourth address of the first local memory; and
storing one pixel segment of P(6, 5), P(6, 6), P(6, 7) and P(6, 8) and another pixel segment of P(8, 5), P(8, 6), P(8, 7) and P(8, 8) in a fourth address of the second local memory,
wherein i and j are variables and P(i, j) represents pixel datum in the i^{th} row and the j^{th} column of the macroblock.

10. The method as claimed in claim 6, wherein the image processing procedure is a deblocking or image rotation procedure.
